(19) United States
(12) Patent Application Publication
(10) Pub. No.: US 2014/0306066 A1
(43) Pub. Date: Oct. 16, 2014

(54) Methods of Delivering Items in Space

(71) Applicant: Matthew Hal Burch, Hampton, GA (US)

(72) Inventor: Matthew Hal Burch, Hampton, GA (US)

(21) Appl. No.: 14/074,983

(22) Filed: Nov. 8, 2013

Related U.S. Application Data
(60) Provisional application No. 61/754,535, filed on Jan. 19, 2013.

(51) Int. Cl. B64G 1/64

(52) U.S. Cl. CPC B64G 1/641; B64G 1/646
USPC 244/172.4

(57) ABSTRACT

This claim is for methods of delivering items in space which allow for increases in the efficiency of mass based propulsion systems. This claim is based upon existing knowledge that professionals in the field of rocketry should understand with no need of reference materials.

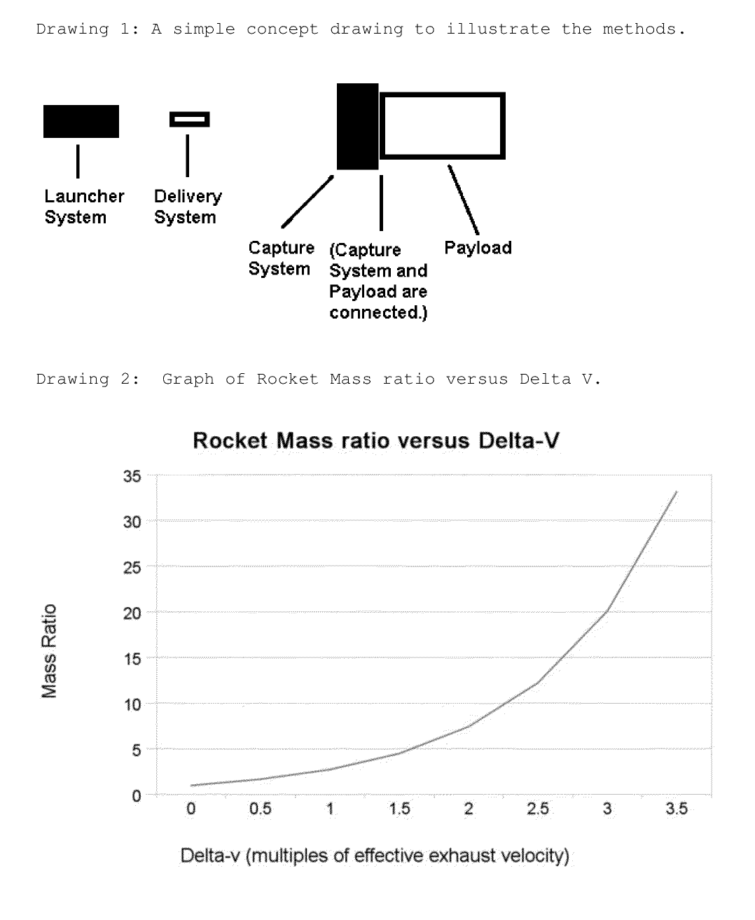

### CROSS-REFERENCE TO RELATED APPLICATIONS

This application claims the benefit of PPA application #61754535, filed 19 Jan. 2013 by the present inventor, which is incorporated by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1) “Electromagnetic Launch of Lunar Material” By William R. Snow and Henry H. Kolm, NASA SP-509
A) Restricted to sourcing oxygen and hydrogen or water from the moon into space near the moon, not performing as a part of a propulsion system.
B) This prior art was also written when hydrogen's presence on the moon had not been quantified in significant mass in any verifiable manner. The lunar observations and analysis performed by Chandrayaan-1, Deep Impact, and Cassini indicate that Hydrogen and Water both exist in significant quantities on the moon. This means that the above proposal does have potential for supplying at least some, and potentially large amounts of water for use in space from the moon—but it's not intended as part of a propulsion system.

2) The Star Tram project By Dr. James Powell and Dr. George Maise
A) Earth based launching system. Similar in intent to the “Electromagnetic Launch of Lunar Material” prior art above, except the launch would be to Earth orbit. Not intended as a component of a propulsion system.
B) This system might be the most efficient method of initially getting components of a large scale accelerator into space, but the limited trajectories and massive power requirements to accelerate payloads out of Earth's gravity well would make it far less suitable as component of a large scale space propulsion system than a system based in space, or in a much weaker gravity well.

3) “Forget space travel: it's just a dream” by Alan Finkel in Cosmos Online 11 Apr. 2011
A) Physics argument: “an enormous amount of energy is required to send a human payload out of Earth's gravitational field to its deep space destination and back again.” This is true, but an assumption is made that all of the required energy to accelerate the fuel and the payload itself would be carried in one body with the payload.
B) Chemistry argument: “there is a hard limit to how much energy you can extract from the rocket fuel, and that no amount of ingenuity will change that.” This is true, but far less of an impediment than the author implies, provided that you avoid accelerating all of the fuel and all of the payload as one body.

4) “MASS DRIVER UP-DATE” by Henry Kolm From L5 News, September 1980
A) In this article, Mr Kolm indicates that it was possible in 1980 to launch a 1000 kg projectile out of Earth Atmosphere from a 7.8 km launcher using the cumulative power output of a 1000 MW power plant for 1.5 minutes. This technology is now 30+ years out of date.
B) Mr Kolm mentions using this system as an Earth-based launcher to dispose of nuclear waste, or to send fuel into orbit, not as a component of a propulsion system.

5) “Ram Accelerator Direct Launch System for Space Cargo” IAF-87-211 by A. P. Bruckner and A. Hertzberg from Aerospace and Energetics Research Program, University of Washington.
A) In this article, the plausibility of a “ram accelerator” is discussed. A “ram accelerator” being a chemically powered, “direct launch of cargo to low Earth orbit” device with the capacity for the projectile to have limited self-propulsive capability for orbital maneuvering.

6) “Physics of rocket systems with separated energy and propellant” by Anthony Zuppero from Idaho National Engineering and Environmental Laboratory. Original INEEL version 31 Dec. 1998. Revised 21 Sep. 2010
A) This article speaks to the efficiencies of propellant types more than mechanics of delivering fuel, but it does mention a fueling station. There is no mention of accelerating fuel to meet the payload. A payload docks and takes on fuel rather than carrying fuel from the Earth's surface with a single launch, or receiving fuel incrementally during its journey.
B) There is no mention of actually delivering fuel to the payload so it can return to Earth, further demonstrating that this article is merely an exercise in calculating efficient acceleration of an item from Earth's orbit to a distant location, rather than a method of delivering fuel.

7) Spaceship Propulsion by Momentum Transfer by Robert C Willis, USPTO #5305974
A) Requires both an electromagnetic accelerator system and a potent power generation system to be accelerated along with a payload, significantly increasing the actual accelerated mass.
B) The launcher is an EM launcher, and the propulsion system of the payload is also an EM launcher, which absorbs the momentum of the incoming launched projectiles. This proposal is narrow in scope and includes a high level of potential failure points at the payload end, where service and repair efforts will be drastically limited while the payload is in flight.
C) The number of course corrections allowed by the payload would be limited to the number of projectiles that it has managed to capture, and the available energy to accelerate said projectiles. There might also be some small amount of maneuvering that the payload could perform with chemical fuel.
D) A minor error in calculations could result in a hypervelocity projectile impacting the drive system. You cannot robustly protect this propulsion system, while at the same time capturing incoming projectiles to generate momentum transfer, because those two actions are performed by the same system. For there to be significant transfer of energy, the incoming projectile must be moving substantially more rapidly than the payload it approaches.
E) The energy for acceleration at the end of journey in order to stop the payload must be provided internally, or a collector system for solar energy must be included, requiring even more mass. Stopping this ship by using its own internal launcher will suffer from the same mass-to-accelerate-the-mass issue that simply carrying any other type of fuel would have. You need projectile mass and power to accelerate the ship, and the payload will have to supply all of its power and mass needs at the end of its journey.

8) “Interstellar propulsion opportunities using near-term technologies” by Dana G Andrews from New Opportunities for Space. Selected Proceedings of the 54th International Astronautical Federation Congress Volume 55, Issues 3-9, Pages 159-816 (August-November 2004)
A) “Interstellar transportation over periods shorter than the human lifetime requires speeds in the range of 0.2-0.3c. These speeds are not attainable using rockets, even with advanced fusion engines. Anti-matter engines are theoretically possible but current physical limitations would have to be suspended to get the mass densities required. Interstellar ramjets have not proven practicable, so this leaves beamed momentum propulsion as the remaining candidate.” This only holds true if one tries to carry all of one's fuel and payload in one lump, or a very small number of stages. There are multiple methods of acceleration, including mass based propulsion systems, which would provide sufficient acceleration to get a modest payload up to 0.2-0.3c. The faster one wants to go, the greater the infrastructure expenses, but to start with, for interplanetary travel, we can manage things just fine with mass based propulsion system methods if we don't try to carry the full fuel payload with us all at once. As for interstellar travel, the infrastructure requirements for accelerating fuel up to 0.2 to 0.3c are daunting but not insurmountable once we actually get into space with a significant industrial presence.

9) “High-acceleration Micro-scale Laser Sails for Interstellar Propulsion” by Jordin Kare from NIAC Research Grant #07600-070 on 31 Dec. 2001 (Revised 15 Feb. 2002)
A) Cannot carry cargo, is a pure propulsion system.
B) Adjustment of the course of the micro-scale sails is possible, but the maneuverability of the payload during acceleration would be extremely limited.
C) Accelerating back to low velocities would be limited to magnetic sails and/or solar sails, which limits the maximum velocity of the payload if it is expected to stay at its destination rather than performing a flyby.

10) “Method for lightening the weight of fuel stowed onboard during an interplanetary mission” by Sainct, et al. from USPTO #8322659
A) Two independent spacecraft are used for this technique.

11) “A superconducting Quenchgun for Delivering Lunar Derived Oxygen to Lunar Orbit” by Nathan Nottke and Curt Bilby from Large Scale Programs Institute, Austin Tex., APR1990
A) Example of Quench Gun research

12) “Launch to Space with an Electromagnetic Railgun” by Ian R. McNab from IEEE TRANSACTIONS ON MAGNETICS, VOL. 39, NO. 1, JANUARY 2003
A) This is a ground to orbit delivery system.

13) “The Tyranny of the Rocket Equation” by Don Pettit from International Space Station expedition 30. www.nasa.gov/mission_pages/station/expeditions/expedition30/tryanny.html
A) The author mentions staged rockets, but does not consider in flight fueling.

14) “Method and apparatus for moving a mass” by Westmeyer; Paul A. (Laurel, Md.), Mazaheri; Renee (Laurel, Md.) USPTO #7500477
A) Only considers launching from a gravity well in its embodiments, specifically stating “The use of remote fuel for launching and for propelling orbital and suborbital vehicles is new and not suggested in prior art.”
B) Only considers high energy explosive and momentum transfer methods to accelerate payload.
C) Payload design requires a large degree of armoring and protective mass in order to protect the payload from explosions or excessive acceleration effects required by the acceleration methods described.
D) No provision is made for the delivery of non-fuel cargo.

Prior to this method, there were three basic classes of propulsion systems that might be used for space exploration, each with their own problems:
1) Mass based propulsion systems were considered impractical due to the unnecessary restriction of being required to carry all or most of the mass required for a voyage from the beginning of the voyage. Since no in-transit delivery system had been considered which could be used for fuel delivery, total delta-v available to a mission built around mass based propulsion was extremely limited.
2) Experimental or excessively dangerous methodologies, some examples being nuclear powered rockets or Orion bomb propulsion. These are unproven, immature technologies, or simply too dangerous to implement.
3) High energy systems where propulsion is provided remotely based on lasers, particle beams, etc. Impractical due to mission duration, engineering scalability, and microgravity health issues for crews due to low accelerations, amongst other things.

There are only two acceleration technologies discovered in prior art that are superficially similar to the claim made within this document. They are both based on proven technologies, and could potentially be built with today's technology. They are “Spaceship Propulsion by Momentum Transfer” by Robert C Willis, USPTO#5305974, and “Method and apparatus for moving a mass” by Westmeyer; Paul A. (Laurel, Md.), Mazaheri; Renee (Laurel, Md.) USPTO #7500477

I will discuss “Spaceship Propulsion by Momentum Transfer” first. This method by definition requires electromagnetic launchers both to accelerate a projectile, and to slow said projectile at the payload itself, generating a momentum transfer exactly as its title implies. This means that the propulsion system of the accelerated mass is in direct and immediate danger every time there is a momentum transfer because the projectile capture system is also the drive system. Additionally, the onboard electromagnetic receiver/launcher requires a power source capable of generating sufficient energy to power said onboard electromagnetic launcher. This is especially a concern for acceleration at mission end for non-flyby missions. Between the electromagnetic drive system and the power plant, there is a lot of massive, highly complex, and unforgiving mission critical equipment. This might be a potential method for unmanned flyby probes, but not for most intercept missions or missions with a return component.

Now I will discuss “Method and apparatus for moving a mass” by Westmeyer; Paul A. (Laurel, Md.), Mazaheri; Renee (Laurel, Md.) USPTO #7500477. The method is exclusively based on acceleration methods which accelerate a mass along an arcuate path. The launchers mentioned and the acceleration methods described are always related to launching from within a gravity well. The discussion of prior art in USPTO #7500477 clarifies the intended scope of the patent with the statement: “The use of remote fuel for launching and for propelling orbital and suborbital vehicles is new and not suggested in prior art.” The payloads which are described further clarify that the method is designed for leaving a significant gravity well, as the method is described in such a way that the payload must channel significant explosive or impact energy into motive force. No mention is made in the method's description of low energy capture of delivered fuel, or the capture of delivered fuel followed by controlled acceleration. The greater mass, expense, and higher degree of structural engineering required to create a payload capable of withstanding many large impacts or explosions as a design feature for normal acceleration is not necessary for low acceleration systems in space, though some lesser capacity for absorbing explosions or impacts in an emergency would be prudent. As a last note, this method makes no mention of delivering non-fuel to the payload.

Next, let's look at something simpler and broader than these two suggestions. Based on the Tsiolkovsky rocket equation, we can see clearly that the combined mass of payload and fuel being accelerated quickly becomes unreasonable for any mass based propulsion system where all of the fuel required for all delta V requirements are carried as a single mass from the beginning of a maneuver or mission.

Delta V=Exhaust Velocity*[Natural Log(Initial Mass/Final Mass)]

This equation illustrates why nearly all space launches using mass based fuels use fuel stages. Once a stage's fuel is gone, all the unnecessary mass from that stage's fuel containment is discarded, allowing the remaining stages and payload to accelerate with less overall mass. It makes a significant difference to fuel requirements.

This problem is incorrectly perceived to be universal to all mass based propulsion methods and that is why the space exploration community has mostly moved away from using mass based propulsion for space transport within our solar system and beyond. Many highly respected individuals within the space exploration community have gone as far as to declare that mass based propulsion cannot feasibly be used to go very far at all in space in the near term. These individuals look at the math for single stage or multiple stage self-fueled mass based propulsion payloads and see huge mass requirements—and they are right! The simple fact is that we don't have to do it the way that they are imagining it.

### BRIEF SUMMARY OF THE INVENTION

The method described is intended to make mass based fuels more viable for space transport by increasing delta V for any given fuel mass providing propulsion.

### BRIEF DESCRIPTION OF THE SEVERAL VIEWS OF THE DRAWING

There are only two drawings:

Drawing 1: A simple concept drawing to illustrate the methods.

Drawing 2: Graph of Rocket Mass ratio versus Delta V.

### DETAILED DESCRIPTION OF THE INVENTION

### First Embodiment

In order to accomplish in-transit fueling, we need a system that can launch fuel in space to rendezvous with the payload that is using said fuel to accelerate. The choices of example technologies for this embodiment do not limit the scope of the method. The example mass of the primary embodiment were chosen to be close to that of a United States space shuttle, in order to better allow persons familiar with prior space propulsion systems to quickly grasp the utility of the method.

For near term initial implementation of a launcher to move fuel to a 100,000 kg payload within the solar system, the power source for the acceleration of cargo/fuel would almost certainly be solar, either some type of solar thermal energy generation based on mirrors, or photovoltaic. Nuclear energy generation might also work, but would require more complicated engineering for safety and heat dispersal. Undoubtedly there are other technologies which might also produce enough power for the launcher, but most are impractical at this time simply due to mass related requirements to get them into orbit. Solar power generation requires no fuel, no requirement to protect crew from radioactive sources above and beyond what we already expect to encounter in space, and is proven technology, both for solar thermal and for photovoltaic technologies on a large scale. So we'll use solar thermal power as the power source in our example.

Within the limits of current technology, some of the most mass and energy efficient methods of rapidly accelerating masses to velocities measured in kilometers per second are electromagnetic. There are non-electromagnetic methods that might be able to do the job of accelerating a delivery system to high velocities, but for this embodiment we will consider only electromagnetic acceleration.

Quench guns are the most energy efficient of the electromagnetic options. When quench guns were first theorized, they required low temperature superconductors, which in turn required extremely difficult to engineer cooling systems. With modern advances in higher temperature superconductor technologies, the cooling needs of the superconducting components of such a device would not be anywhere near as difficult to engineer. Non-superconducting coilguns or railguns might also work but would be far less energy efficient, likely leading to greater maintenance needs—which might be fine if the cost savings for their design and use warrants it. There are almost certainly other adaptations or combinations of technologies better suited for accelerating a payload in space than a pure electromagnetic quench gun system. Initial acceleration launch systems, for example, which might accelerate a delivery system before it enters the quench gun. The exact technologies used for acceleration are not critical, so this example will use a simple electromagnetic quench gun, with no hybrid system considerations.

Next, let's postulate a solar power system and quench gun launcher system. First let us generate an estimate of how much power we can generate with a 500,000 m̂2 heliostat mirror system used in a space based solar thermal installation. http://en.wikipedia.org/wiki/PS20_solar_power_tower is an example of a fully functional solar thermal energy collection system on Earth. The PS20 facility utilizes 1255 mirrors of 120 m̂2 each to generate 20 MW of power. Roughly 1 MW power generated per 7500 m2 of mirrors. In space, without the effects of Earth's atmosphere, and with 365 day/24 hour exposure to sunlight, doubling this power output per m̂2 of mirror is conceivable. We should be able to generate roughly 1 MW of power per 3750 m̂2 of heliostat mirrors given a similar efficiency to the processes at the PS20 station. A facility with 500,000 m̂2 of heliostat mirror surface area would therefore generate roughly 133 MW of power.

What will 133 MW of power do for us for a launcher? Let's assume a hypothetical 250 kg mass projectile. 50 kg of the mass is components and 200 kg is some type of mass based fuel or payload. How much power would be required to accelerate such a projectile to 10 km/second? Roughly how long would the launcher need to be?

The kinetic energy of a projectile is (½)mv̂2, and we are taking 250 kg to 10000 m/s so we need 12,500,000,000 joules of energy, which our power plant can supply in 12500000000/133000000 seconds or roughly once per 94 seconds. Adjustments for efficiency would need to be made, of course, but the quench gun itself is extremely efficient, and the calculations for power per m̂2 mirror area were based off the operational efficiency of a real world solar power system, so the calculations for the 133 MW power system already include substantial inefficiency.

So let us consider that we will accelerate our delivery system at an average of roughly 10000 g or 100000 m/ŝ2, roughly two-thirds of what electronics in modern artillery shells are rated for. At this acceleration, we can accelerate to 10000 m/s in roughly 0.1 seconds in an acceleration path of roughly 500 meters. There will be inefficiencies, and it might be cost beneficial to make the launcher significantly longer to reduce the rate that the acceleration energy is applied to the launcher, but even with massive inefficiencies, a quench gun less than a kilometer long can launch projectiles at sufficient velocities to be useful for the calculations in this embodiment. Quench guns are theoretically capable of much higher accelerations, but the container, its components, and its contents must also be capable of withstanding the acceleration.

This is a substantial sized system, but it's not out of proportion to the size of the solar energy facility we already discussed. The two could be combined, with the solar facility's mirror system shielding the launcher system from the sun, while providing power for launch and cooling. The combined mass of this embodiment's launcher system and solar facility would be significant enough that it might be necessary to keep it at a Lagrange point in order to minimize gravitational forces acting on it.

Since we are accelerating 250 kg at 10000 g, this embodiment's quench gun system would ideally be as straight and perfectly under control as possible, leading to high degrees of accuracy delivering fuel to the capture system, but the delivery system and the combined package of capture system and payload can both maneuver so minor trajectory errors are correctable, greatly reducing the risk of damage to the capture system and payload. Launching system station keeping might be performed by launching in two directions, negating acceleration of one launch with another, with fine station keeping managed by any number of different technologies.

See Drawing 2: Taking another look at the Tsiolkovsky rocket equation, this time graphically in a comparison of mass ratio to Delta V in multiples of effective exhaust velocity, we can see that any accelerated mass will behave the same when fuel mass is measured against said accelerated mass. This image is from Wikipedia, and is unrestricted use.

First, let us look at the ideal mass requirement for a simple system where all the fuel is carried from launch. With a Hydrogen/Oxygen mass based fuel, effective exhaust velocity of roughly 4462 m/s, if we want to add 10 km/s velocity to the payload, based on the above image we need a mass ratio of roughly 8 to 9. Doing the math for a mass roughly that of a US space-shuttle:

100,000 kg payload mass: oxygen/hydrogen fuel mass required to reach 10,000 m/s

### 10000=4462 Ln(Initial Mass(x)/100000)

### 2.241=Ln(Initial Mass(x)/100000)

### 2.241=Ln(Initial Mass(x))-Ln(100000)

### 2.241=Ln(Initial Mass(x))-11.513

### 13.754=Ln(Initial Mass (x))

940,343=x
Initial mass=payload mass+fuel mass

Fuel mass=840,343 kg for a 10 km/second delta V in space for a 100,000 kg payload powered by hydrogen/oxygen fuel. If we carry it all with us in a single stage. Mass ratio of roughly 8.4, which is what we expected.

Now let's look and see how much acceleration we can get in an ideal scenario with a 100,000 kg payload from each 250 kg container carrying fuel. 50 kg of each delivered container is components, so we include that in accelerated mass.

Ideal acceleration per 200 kg fuel(Y)=4462 Ln(100250/100050)
Y=8.91 m/s acceleration of a 100,000 kg payload powered by a oxygen/hydrogen fuel per each 200 kg of fuel carried in a 50 kg container.
If we want to get 10 km/second of delta V 8.91 m/s at a time, we would need roughly 1125 launches of fuel, or 225,000 kg fuel.

It is clear that the fuel mass savings as a result of delivering mass based fuel in small quantities are significant. For a delta V of 10 km/sec on a 100,000 kg oxygen/hydrogen fueled accelerated mass we go from 840,343 kg fuel mass to 225,000 kg by delivering fuel 200 kg at a time as opposed to carrying the full mass of fuel all at once. In other words we reduce fuel mass ratio requirements from 8.4 to 2.25. This becomes even more remarkable when one realizes that the accelerated mass gains 8.91 m/s of delta V per delivery of 200 kg of fuel, making fuel requirements for missions with a great deal of maneuvering linear, rather than geometric. If you need a delta V of 20 km/sec for a mission that includes multiple complex accelerations, your fuel requirements grow linearly, not exponentially—provided that you do not need to accelerate to a relative velocity in excess of any available launcher system's capability.

So, we fuel in flight, 200 kg of fuel at a time up to 10 km/s relative to the launcher which is the hypothetical limit of this example's electromagnetic launcher. This can be done by launching fuel ahead of the payload and having the payload catch up with it and/or fueling from behind by the launcher directly, or possibly a combination of both, with specifics depending on the requirements of the mission.

What if we want to accelerate to a higher velocity than what our launcher can manage? That's when it might be appropriate to launch large numbers of fuel deliveries to the payload in order to fill fuel tanks that were empty during initial acceleration so the travelling payload could use standard “carry all the fuel with you” rocketry to further accelerate. Half the delta V provided by the delivered fuel could be used to increase velocity, and half would be used to decrease velocity. Since we've already done the math, let's use it. Our 100,000 kg payload is accelerated to 10 km/sec by 225,000 kg of fuel delivered 200 kg at a time. Then the accelerated mass takes on about 850,000 kg of fuel 200 kg at a time, and accelerates up to 15 km/sec, then back down to 10 km/sec with the stored fuel, at which point, fuel launched by the launcher system at the accelerated mass's origin could once again be captured by the accelerated mass.

There is another way to accelerate beyond the capability of an originating launcher system. It requires multiple launcher systems at different velocities within the solar system. This would be a very cost ineffective method for small numbers of payloads, but as space industry advances, it would certainly become attractive, since a Mercury based 10 km/second launcher could accelerate an accelerated mass to 28 km/s in relationship to Earth, while avoiding geometric fuel requirements. Moving cryogenic payloads out of a Mercury orbit might prove problematic due to solar energy—depending on the effectiveness of shielding and heat dispersal—it's just an example of the potential. With a large number of launchers in the solar system, it would be possible to accelerate a delivery system multiple times by multiple launcher systems at different solar orbital velocities, even discounting Mercury. In extreme cases with multiple decades of planning, launchers with eccentric orbits could impart far more velocity than even a Mercury based launcher. Halley's Comet reaches roughly 55 km/sec at perihelion, for example, and it doesn't get as close to the sun as Mercury.

Next, we need to consider return trips. Ideally the first significant mass sent to a site that planning indicates will see many future visits would be some method of power generation, a launcher system, and a capture system, but if that isn't possible, or if the site is a one-time visit, it would also be possible to simply accelerate several containers of fuel in the same manner that the payload itself was accelerated, and have them waiting at the destination for the payload to collect if there is no launcher in place.

Capturing low relative velocity objects in space is already regularly done today to resupply the International Space Station. In our case, both the delivery systems and the combination of capture system and payload can maneuver to match trajectories. The capture system will collect the delivery systems while overtaking them, or while being overtaken by them, or a combination of both depending on the mission. The capture system connected to the payload could be based on any technology which would allow for safely intercepting a delivery system at low relative velocities. Propulsion systems could be components of the capture systems and/or components of the payload and/or the delivery systems' integral maneuvering thrusters. Exact propulsion configuration would be dependent on the mission. Each delivery system will be capable of communicating with the capture system in order to coordinate capture.

The driving concept here is that if we are going to use mass based propulsion systems for space travel, we do not want to carry all of the mass of the fuel with us, all at once, unless the delta V needs are small. There are additional advantages beyond simple fuel efficiency. An advantage of many mass based fuels, especially the simpler chemical fuels, is that the equipment required to utilize them for propulsion is not terribly mass intensive, the mass requirements they have in designs predating this method are significantly impacted by required fuel mass, structural requirements to handle fuel mass, and safety considerations. Since each of the delivery systems has its own propulsion system, it might even be a good idea in some mission designs to simply use the propulsion systems of the delivery systems as the propulsion system for the mission, meaning less mass that must be accelerated and less overall engineering complexity. Nothing stops one from using solar or magnetic sails in conjunction with this method, to assist in acceleration. Various other present or future technologies might be similarly compatible.

Oxygen and hydrogen were specifically chosen as fuels for this example because they are relatively easy to acquire and process, and are known to be available in several places around the solar system. Oxygen and hydrogen delivered to the accelerated mass could be used to meet oxygen and water needs of a crew. In a highly efficient closed loop system that consideration might not be of paramount concern, and other fuels might be used—with any oxygen or water needs supplied as required. Other deliveries of supplies could also be considered if they can survive the acceleration of the launcher. For example plastic, ceramic, and metallic stock for use by 3d printers, dried food stocks, hardened electronics, medical supplies, and anything else that might both be useful and capable of surviving acceleration to match velocities with the accelerated mass. The shells of the delivery systems themselves, once cargo or fuel is removed, could be used as sensor, beacon, or communications platforms. They might also be broken down for raw materials for use in repairs or simply added to the ship as enhancements to radiation and/or micrometeorite shielding. In the absence of any other use, the empty delivery systems could just be discarded in space with a small amount of fuel and instructions to enter a degrading orbit to fall into a star or planet. It's also conceivable that the delivery systems might be outfitted with small solar sails and solar panels so they would need no fuel to accomplish self-destruction or self-positioning as a beacon or communications relay. In an established back and forth traffic pattern between destinations, delivery systems might even be launched, captured, emptied, released, then be retrieved and recycled.

Any engineer that looks at the first embodiment of the method and sees the size of the constructs, and starts thinking about the math is going to immediately realize that a system like what was described for a 100,000 kg accelerated mass is going to be rather substantially expensive compared to simply taking a little more time or using a lot more fuel to get to nearby destinations in space a few times. For any sort of relatively fast construction/implementation of the first embodiment, some sort of low cost Earth to orbit heavy lift system would probably need to be built, adding large scale costs to the project before it's even started. On the other hand, this system has a great deal more to offer than sending a limited number of ships to a limited number of destinations.

The launcher system can be used to:

1) supply fuel to many ships over time,
2) supply power for other space based industries when not actively accelerating fuel, or when actively accelerating fuel to low velocities,
3) provide mobility to asteroids to move them to where they can be refined, then moving the resulting refined materials to where they need to go,
4) dispose of nuclear or other waste products,
5) engage Near Earth Objects to break them up or deflect them, and
6) establish other launchers near other fuel sources or useful places throughout the solar system.

In other words if this method were implemented on a significant scale its implementation would almost certainly become a core component or keystone of space industry, space exploration, and effective protection of the planet from Near Earth Objects. In many potential embodiments, it is also highly expandable by adding more power generation or by increasing the capacity of the launcher system itself.

### Second Embodiment

It would be very difficult to justify an initial implementation of this method at anything approaching the capacity described in the first embodiment above. There is no need for a hugely expensive new heavy lift system or new multibillion dollar support systems for a simpler test case. Ideally, the test case would need to be at least capable of defraying its own costs during development and study. There are a few different, plausible methods to do this, two obvious methods are discussed a bit later.

It would be relatively inexpensive to put a very small launcher system in space and use it to launch fuel or even equipment to small probes exploring the asteroid belt or other places in the solar system. Thoroughly surveying the asteroid belt with small probes would be ideal as a first step towards a real human space presence. We could learn what metals and other compounds are available and accessible, including water, which would help us decide where to put the first small launcher in or near the asteroid belt, with plans for future industrial and human expansion over time.

Since we want easy and simple for a test system, a photovoltaic solar panel array connected to a small electromagnetic launcher used to launch very small delivery systems could be used to keep a few probes flying around in the asteroid belt, surveying for resources worth harvesting. It would be efficient to have two probes active in different places, so you could accelerate the launcher system in one direction with one launch, then the other direction with the next, maintaining orbit, without wasting delivery system containers or launch energy.

How could this system generate income to defray costs? There are at least two obvious methods for the earliest implementations. One obvious method would be to simply provide fuel delivery to probes that others have designed to be compatible with the fuel delivery system. A second obvious method (which might be performed simultaneously) would be to control one's own survey drones to survey asteroids for valuables, and either sell the survey data or reposition and harvest the asteroids if they are sufficiently valuable. Recovery or destruction of damaged probes or other space junk could also be performed with whatever systems are designed for repositioning asteroids.

Mining asteroids by bringing them near Earth for processing is nothing conceptually new, people have been thinking about how to do it for decades. The problem has been the process of finding and moving them. This method provides insight into many potential possibilities for both getting relatively cheap, long-lived sensor payloads to the asteroid belt with the ability to maneuver at need, and for providing the fuel or materials required to move asteroids as appropriate for resource retrieval.

Even a test system will be expensive. Putting things in space isn't cheap. Building them to operate there for extended periods is certainly not cheap. But there's another hidden benefit here. Intelligently providing fuel as needed rather than trying to carry it all at once for an entire mission has the potential to drastically reduce the mandatory complexity and expense of payload design, even for small probes. Less expensive materials and less precise machining could be a catalyst to drastically lower design and fabrication costs of probes. Heavier shielding might allow for less expensive electronics. Simply not requiring significant fuel storage could increase payload mass budgets. Even a very small pilot system could drastically reduce the cost of exploring our solar system while teaching us the things we need to know to be able to start building a space based industry with confidence. Then again, engineers might choose to continue to use high cost materials and equipment, and simply create much more capable payloads or in the case of crewed missions, similarly capable payloads with a great deal more radiation shielding and redundant life support for crew.

I Claim:

1. Methods of delivering items in space, comprising:
a) a launching system capable of accelerating a delivery system,
b) a delivery system that is capable of:
1) changing its own trajectory in transit to a capture system,
2) carrying multiple types of items, and
c) a capture system capable of collecting launched delivery systems,
whereby a payload in space attached to the capture system can have items delivered to it while having the capacity to maneuver.
